(19) United States
(12) Patent Application Publication
(10) Pub. No.: US 2023/0314458 A1
(43) Pub. Date: Oct. 5, 2023

(54) AUTOMATIC ANALYZER, WORK SUPPORT DEVICE, AND AUTOMATIC ANALYSIS SYSTEM

(71) Applicant: Hitachi High-Tech Corporation, Tokyo (JP)

(72) Inventors: Keiko YOSHIKAWA, Tokyo (JP); Hiroyuki TAKAYAMA, Tokyo (JP)

(21) Appl. No.: 18/022,352

(22) PCT Filed: Mar. 16, 2021
(86) PCT No.: PCT/JP2021/010619

§ 371 Date: Feb. 21, 2023

(30) Foreign Application Priority Data
Sep. 29, 2020 (JP) 2020-162909

(51) Int. Cl. G01N 35/02

(52) U.S. Cl. CPC G01N 35/02; G01N 2035/0489

(57) ABSTRACT

An object of the present invention is to provide an automatic analyzer that can reduce manual work by an operator. The present invention provides an automatic analyzer that includes a drive mechanism that is driven to use a specimen or reagent stored in a storage member, a controller that controls the drive mechanism, and a communication unit that communicates with a work support device that performs work support to support work of loading and/or unloading the storage member. The controller controls the drive mechanism to perform a preparation operation for the work and controls the communication unit to transmit an instruction signal for the work support to the work support device.

### TECHNICAL FIELD

The present invention relates to an automatic analyzer, a work support device, and an automatic analysis system.

### BACKGROUND ART

In recent years, urine and other tests are becoming centralized, and there is a growing need to efficiently process a large number of samples by a small number of operators. Therefore, attempts have been made to automate some of work that is maintenance and the like and was conventionally performed by operators.

For example, Patent Literature 1 discloses an automatic analyzer that uses a robot arm to transport a reagent bottle from a predetermined position into reagent storage to replace the reagent bottle (storage member) (paragraphs 0031 to 0035 and the like of Patent Literature 1).

### CITATION LIST

### Patent Literature

Patent Literature 1: Japanese Unexamined Patent Application Publication No. 2014-178311

### SUMMARY OF INVENTION

### Technical Problem

However, even when the storage member is automatically transported as described in Patent Literature 1, it is necessary to perform manual work by an operator for a part of loading and/or unloading, such as an operation on the reagent storage side.

An object of the present invention is to provide an automatic analyzer, a work support device, and an automatic analysis system that are able to reduce manual work by an operator.

### Solution to Problem

To solve the above-described problems, the present invention provides an automatic analyzer that includes a drive mechanism that is driven to use a specimen or reagent stored in a storage member, and a controller that controls the drive mechanism. The automatic analyzer includes a communication unit that communicates with a work support device that performs work support to support work of loading and/or unloading the storage member. The controller controls the drive mechanism to perform a preparation operation for the work and controls the communication unit to transmit an instruction signal for the work support to the work support device.

In addition, the present invention provides a work support device that performs work support to support work of loading and/or unloading a storage member that is used in an automatic analyzer includes a communication unit that communicates with the automatic analyzer, a traveling unit that travels to a location different from the automatic analyzer according to a type of the storage member, a hand that grips and releases the storage member, an arm that moves the hand to a predetermined position, and a controller that controls the communication unit, the traveling unit, the hand, and the arm. When the communication unit receives a first instruction signal from the automatic analyzer, the controller causes the traveling unit to complete the movement to the predetermined position, and causes the communication unit to transmit a movement completion signal to the automatic analyzer after the completion of the movement. When a preparation operation by the automatic analyzer is completed and the controller receives a second instruction signal from the automatic analyzer, the controller causes the arm and the hand to support unloading or loading of the storage member.

Further, the present invention provides an automatic analysis system including an automatic analyzer and a work support device that communicates with the automatic analyzer to perform work support to support work of loading and/or unloading of a storage member that is used in the automatic analyzer. The automatic analyzer includes a drive mechanism that is driven to use a specimen or reagent stored in the storage member. The work support device includes a hand that grips and releases the storage member, and an arm that moves the hand to a predetermined position. When work of loading and/or unloading of the storage member is performed, the automatic analyzer controls the drive mechanism such that the storage member can be loaded and/or unloaded, transmits an instruction signal to the work support device. When the work support device receives the instruction signal from the automatic analyzer, the work support device controls the arm and the hand to complete the work support and transmits a completion signal to the automatic analyzer after the completion of the work support.

### Advantageous Effects of Invention

It is possible to provide an automatic analyzer, a work support device, and an automatic analysis system that are able to reduce manual work by an operator.

### BRIEF DESCRIPTION OF DRAWINGS

FIG. 1 is a schematic configuration diagram of an automatic analysis system according to an embodiment.

FIG. 2 is a functional block diagram of the automatic analysis system according to the embodiment.

FIG. 3 is a flowchart illustrating a procedure for work regarding loading and/or unloading of a storage member in the automatic analysis system according to the embodiment.

FIG. 4A is a flowchart illustrating a procedure for work regarding unloading of a reaction vessel in an automatic analysis system according to Example 1.

FIG. 4B is a flowchart illustrating a procedure for work regarding loading of a reaction vessel in the automatic analysis system according to Example 1.

FIG. 5 is a flowchart illustrating a procedure for work regarding loading and/or unloading of a detergent bottle in an automatic analysis system according to Example 2.

FIG. 6 is a flowchart illustrating work regarding loading and/or unloading of a reagent vessel in an automatic analysis system according to Example 3.

### DESCRIPTION OF EMBODIMENTS

Embodiments of the present invention are described in detail with reference to the drawings.

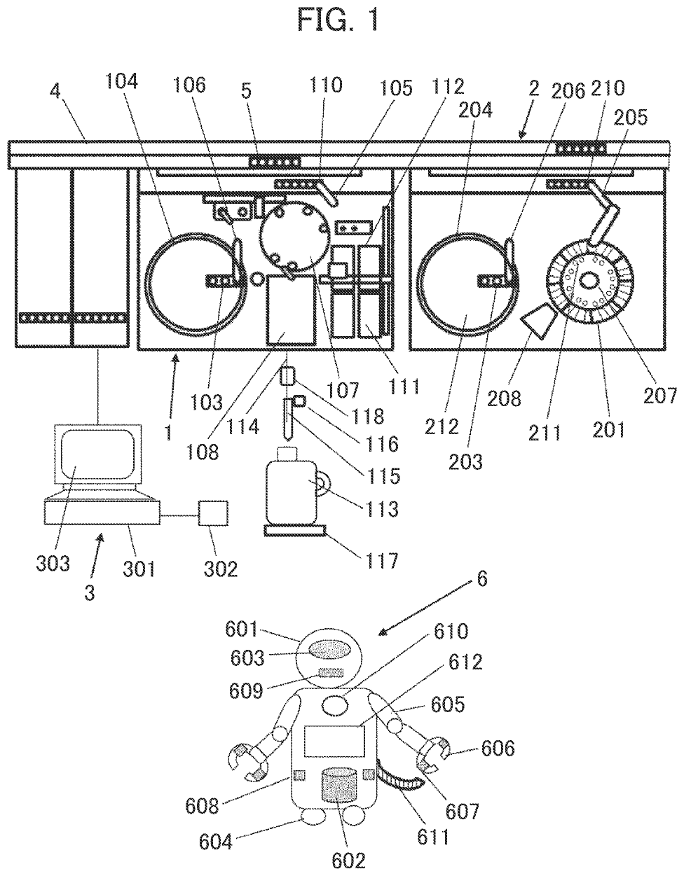

FIG. 1 is a schematic configuration diagram of an automatic analysis system according to the present embodiment. As illustrated in FIG. 1, the automatic analysis system according to the present embodiment includes an analyzer 1, an analyzer 2, a control device 3, a specimen transport device 4, and a work support device 6.

The analyzer 1 mainly analyzes an immunity item and includes a reagent cooler 104, a specimen dispensing mechanism 105, a reagent dispensing mechanism 106, a reaction acceleration unit 107, and a measurement unit 108. The reagent cooler 104 controls a temperature of a reagent vessel 103 storing a reagent to be used for analysis to be within a predetermined temperature range. The specimen dispensing mechanism 105 dispenses a specimen within a specimen vessel 5 into the reagent vessel. The reagent dispensing mechanism 106 dispenses the reagent within the reagent vessel 103 into the reaction vessel. The reaction vessel storing a reaction solution in which the specimen and the reagent are mixed is set on the reaction acceleration unit 107, and the reaction acceleration unit 107 accelerates the reaction by maintaining the reaction solution in a predetermined temperature range. An example of the reaction acceleration unit 107 is an incubator that controls a temperature by heating its surroundings by a heater or the like in a state in which a plurality of reaction vessels are arranged on the circumference. The measurement unit 108 optically measures a quantity of a substance in the reaction solution in which the reaction is accelerated by the reaction acceleration unit 107. For example, the measurement unit 108 measures a quantity of light emitted when the reagent is added to the reaction solution and a voltage is applied.

Depending on analytical performance required for the analyzer 1, carryover between specimens may be taken into consideration, and when the specimen dispensing mechanism 105 dispenses a specimen, and each time the specimen is changed, a replaceable dispensing tip may be used at a part that comes into contact with the specimen, and an unused reaction vessel may be used for each time. In this case, the dispensing tip used once and the reaction vessel used once are discarded. Therefore, a new dispensing tip and a new reaction vessel that are required to perform analysis for a predetermined time period are stored in a consumable storage unit 111 and supplied by a consumable transport unit 112 to a location where the new dispensing tip and the new reaction vessel are used.

In addition, the analyzer 1 includes a detergent bottle 113 storing a detergent that is a system reagent. The analyzer 1 uses a pump or the like to suck up the detergent within the detergent bottle 113 and causes the detergent to flow to the measurement unit 108 so as to clean the inside of the measurement unit 108 for each time of measurement. A flow path 114 from the detergent bottle 113 to the measurement unit 108 is formed of a resin tube or the like and has a metal nozzle 115 at a distal end on the detergent bottle 113 side. The metal nozzle 115 is connected to a belt that is driven by a motor, and can be moved upward and downward by this drive mechanism. To aspirate the detergent within the detergent bottle 113, the nozzle 115 is moved downward such that the distal end of the nozzle is immersed in the liquid surface of the detergent. On the other hand, to replace the detergent bottle 113, the nozzle 115 is moved upward such that the distal end of the nozzle 115 is at a position higher than an upper end of the detergent bottle 113. In this case, conventionally, an operator performs work of removing the detergent bottle 113 used and setting a new detergent bottle 113. However, as described below, in Example 2, a work support device 6 supports such work. In an automatic analyzer according to Example 2, a nozzle detector 116 that detects the height of a nozzle 115 is also used to replace a detergent bottle 113.

Since the capacity of the detergent bottle 113 is already determined, the control device 3 (work time calculator described later) can calculate an available capacity of the detergent bottle 113 based on information of a time when a detergent bottle 113 was previously replaced, the number of times that the detergent bottle 113 was used, and the like. Alternatively, to accurately detect a remaining amount of the detergent, a liquid surface detector 118 may be provided in the middle of the flow path 114. When it is estimated that the remaining amount of the detergent is equal to or less than a predetermined amount, the control device 3 issues an alarm to alert the operator that it is almost time to replace the detergent bottle 113. In addition, for example, even when two or more detergent bottles 113 are set, one of the detergent bottles 113 is empty, and an alarm is issued, the nozzle 115 may be automatically switched to the other detergent bottle 113 and cleaning and measurement operations may not be stopped. The remaining amount of the detergent may be detected by a weight sensor 117 provided under the detergent bottle 113 or a liquid surface height detection sensor provided in the detergent bottle 113.

Meanwhile, the analyzer 2 analyzes a biochemical item and includes a reagent cooler 204, a specimen dispensing mechanism 205, a reagent dispensing mechanism 206, and a measurement unit 208 in a similar manner to the analyzer 1. The analyzer 2 also includes a reagent disk 207. A plurality of reagent vessels 201 storing a reaction solution in which a specimen and a reagent dispensed are mixed are arranged on the circumference of the reaction disk 207. The reaction disk 207 is rotatable by a drive mechanism. The reaction vessels 201 are fixed onto the reaction disk 207 by fixing screws 211. In addition, the measurement unit 208 of the analyzer 2 measures light absorbance of the reaction solution within the reaction vessels 201 supported on the reaction disk 207.

A reagent disk (not illustrated) is provided in the reagent cooler 204. A plurality of reagent vessels 203 are arranged on the circumference of the reagent disk. In addition, a lid 212 is attached to an upper opening portion of the reagent cooler 204 to prevent cold air from leaking and prevent a reagent from vaporizing. The lid 212 can be locked and unlocked by a drive mechanism (not illustrated).

Next, the control device 3 includes a controller 301 that controls operations, temperatures, and the like of the drive mechanisms included in the analyzers 1 and 2, a communication unit 302 that transmits and receives a signal to and from the work support device 6, a display unit 303 that displays an analysis result and an alarm, and an operation unit (not illustrated) to be used by an operator to perform inputting. In FIG. 1, the control device 3 is commonly provided for the analyzers 1 and 2. However, each of the analyzers 1 and 2 may include a control device 3. In addition, the specimen transport device 4 transports a specimen vessel 5 such as a blood collection tube storing a sample (specimen) to be analyzed to specimen aspiration positions 110 and 210.

The work support device 6 according to the present embodiment supports work of unloading and loading storage members used in the analyzers 1 and 2, such as the reaction vessel, the detergent bottle 113, and the reagent vessel 203. As the work support device 6, a self-propelled robot that is autonomously drive is assumed. The work support device 6 according to the present embodiment includes a communication unit 610 that transmits and receives a signal to and from the communication unit 302 on the automatic analyzer side, a traveling unit 604 such as a wheel for traveling to a different position according to a type of a storage member, a hand 606 that grips and releases the storage member, and an arm 605 that moves the hand 606 to a predetermined position. The hand 606 is rotatable and can tighten and untighten a screw by rotating while griping the screw or the like.

In addition, the work support device 6 includes a reader 609 that reads identification information given to the storage member, such as a barcode or a two-dimensional code, an aspiration unit 611 that aspirates condensed water on the back of the lid 212 of the reagent cooler 204, and a storage member holder 612 that holds a storage member to be newly loaded onto the analyzers 1 and 2 and a storage member to be unloaded for discarding. The work support device 6 includes a camera 603 that recognizes a positional relationship of an object targeted for work support via image recognition, an obstacle sensor 608 that detects an obstacle and prevent contact, a hand opening/closing detector 607 that detects opening and closing of the hand 606, and the like.

A controller 602 installed in a body 601 of the work support device 6 controls each of the units described above. In addition, the work support device 6 according to the present embodiment can receive GPS position information via the communication unit 610.

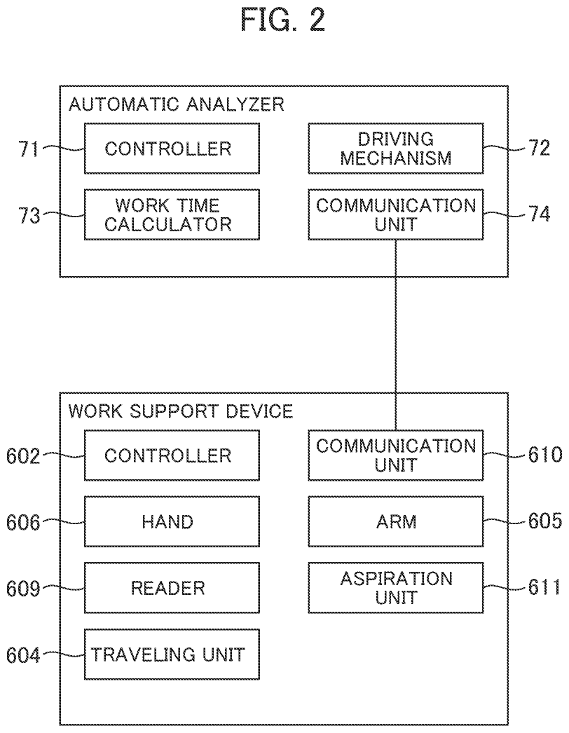

FIG. 2 is a functional block diagram of the automatic analysis system according to the present embodiment. In this case, the analyzer 1, the analyzer 2, the control device 3, and the specimen transport device 4 are defined as an automatic analyzer, and functions of the automatic analyzer are divided into a controller 71, a drive mechanism 72, a work time calculator 73, and a communication unit 74.

The drive mechanism 72 of the automatic analyzer includes the specimen dispensing mechanisms 105 and 205, the reagent dispensing mechanisms 106 and 206, a mechanism (Example 1 described below) that rotates the reaction disk, a mechanism (Example 2 described below) that moves the nozzle 115 in a vertical direction, a mechanism that locks and unlocks the lid 212 of the reagent cooler 204, and the like. In addition, the work time calculator 73 of the automatic analyzer calculates a work time to perform work of loading and/or unloading a storage member. The controller 71 of the automatic analyzer transmits an instruction signal to the work support device 6 based on the work time calculated by the work time calculator 73. The communication unit 74 of the automatic analyzer and the communication 610 of the work support device 6 may directly transmit and receive a signal to and from each other using near-field wireless communication or may transmit and receive a signal to and from each other via a router and a network.

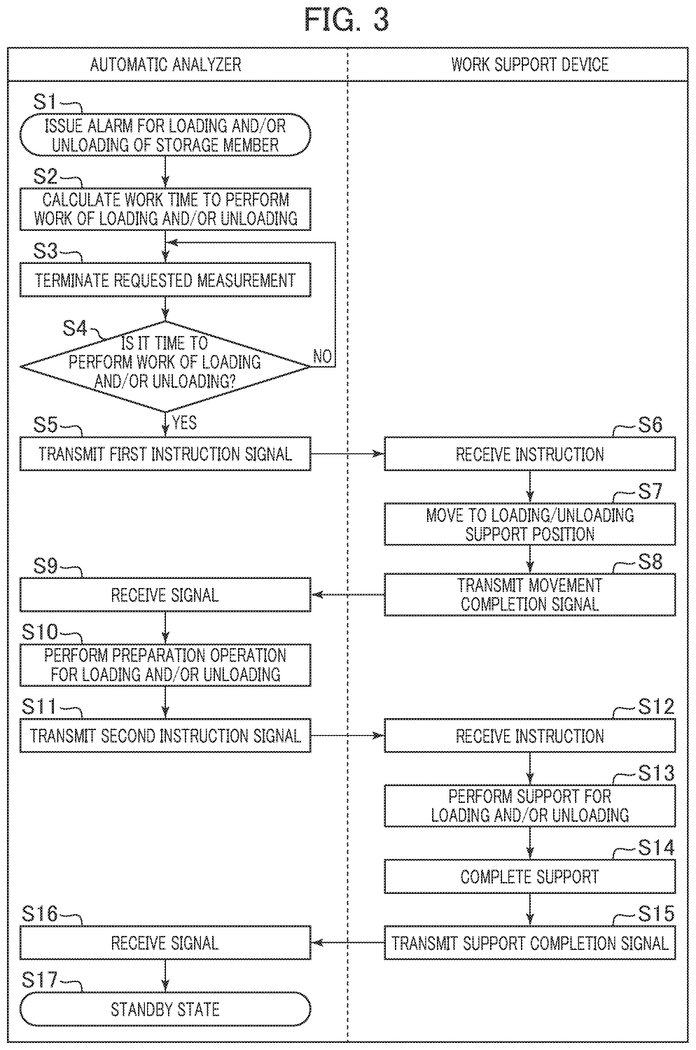

FIG. 3 is a flowchart illustrating a procedure for work regarding unloading or loading of a storage member in the automatic analysis system according to the present embodiment. First, the automatic analyzer issues an alarm to notify that it is almost time to load and/or unload the storage member based on information a remaining amount of a reagent or the like in the storage member, the time of the previous loading and/or unloading, and the like (step S1). Next, the work time calculator 73 of the automatic analyzer calculates a work time to perform work of loading and/or unloading the storage member based on the above-described remaining amount, the time of the previous loading and/or unloading, information of requested measurement (step S2). After that, when the requested measurement is terminated (step S3), the controller 71 of the automatic analyzer determines whether it is the loading and/or unloading work time calculated by the work time calculator 73 (step S4). When the controller 71 determines that it is not the loading and/or unloading work time, the procedure proceeds to the next measurement again. On the other hand, when the controller 71 determines that it is the loading and/or unloading work time, the procedure proceeds to work of loading and/or unloading the storage member, and the controller 71 transmits a first instruction signal to the work support device 6 via the communication unit 74 (step S5). Since the storage member is loaded and/or unloaded when the requested measurement operation is terminated, it is possible to suppress stopping the measurement operation in the middle of the measurement operation.

When the communication unit 610 of the work support device 6 receives the first instruction signal from the automatic analyzer (step S6), the controller 602 of the work support device 6 controls the traveling unit 604 to cause the traveling unit 604 to travel and move to a predetermined loading/unloading support position (step S7).

When the movement to the loading/unloading support position is completed, the communication unit 610 of the work support device 6 transmits a movement completion signal to the automatic analyzer (step S8).

When the communication unit 74 of the automatic analyzer receives the movement completion signal from the work support device 6 (step S9), the controller 71 of the automatic analyzer controls the drive mechanism such that the storage member can be loaded and/or unloaded as a preparation operation for loading and/or unloading (step S10). When the preparation operation is completed, the communication unit 74 of the automatic analyzer transmits a second instruction signal to the work support device 6 (step S11).

When the communication unit 610 of the work support device receives the second instruction signal from the automatic analyzer (step S12), the controller 602 of the work support device 6 causes the arm 605 and the hand 606 to support the loading or unloading of the storage member (step S13). When the support for the loading or unloading of the storage member is completed (step S14), the communication unit 610 of the work support device 6 transmits a support completion signal to the automatic analyzer (step S15).

When the communication unit 74 of the automatic analyzer receives the support completion signal from the work support device 6 (step S16), the automatic analyzer goes into a standby state to wait for a next measurement operation (step S17).

Specific procedures for the loading and/or unloading of a storage member are described below using Examples 1 to 3.

### Example 1

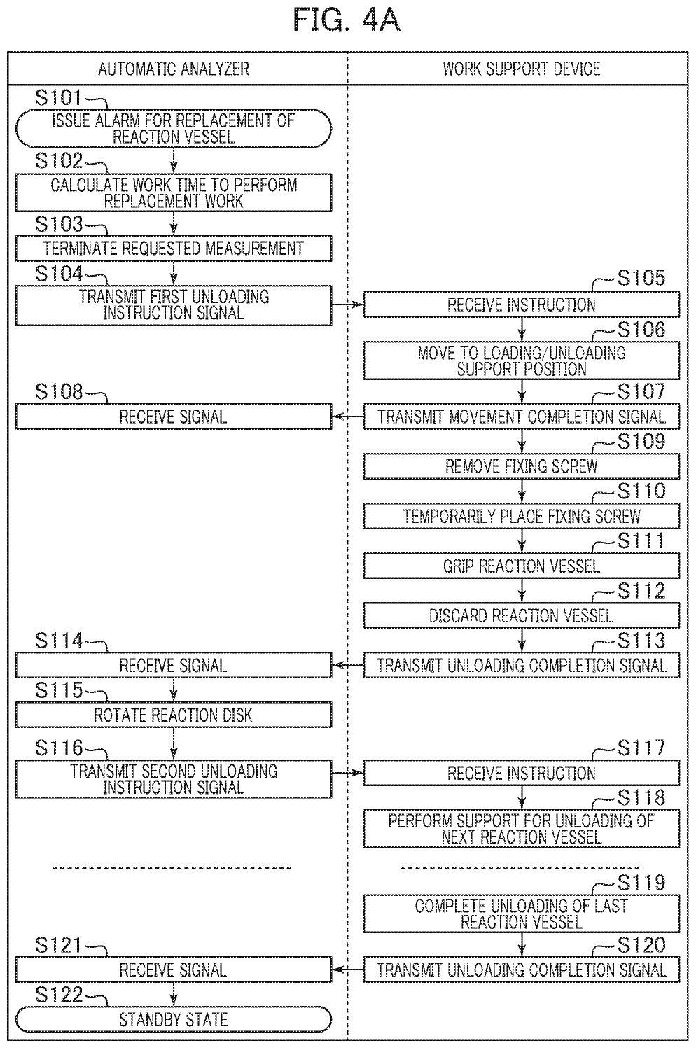

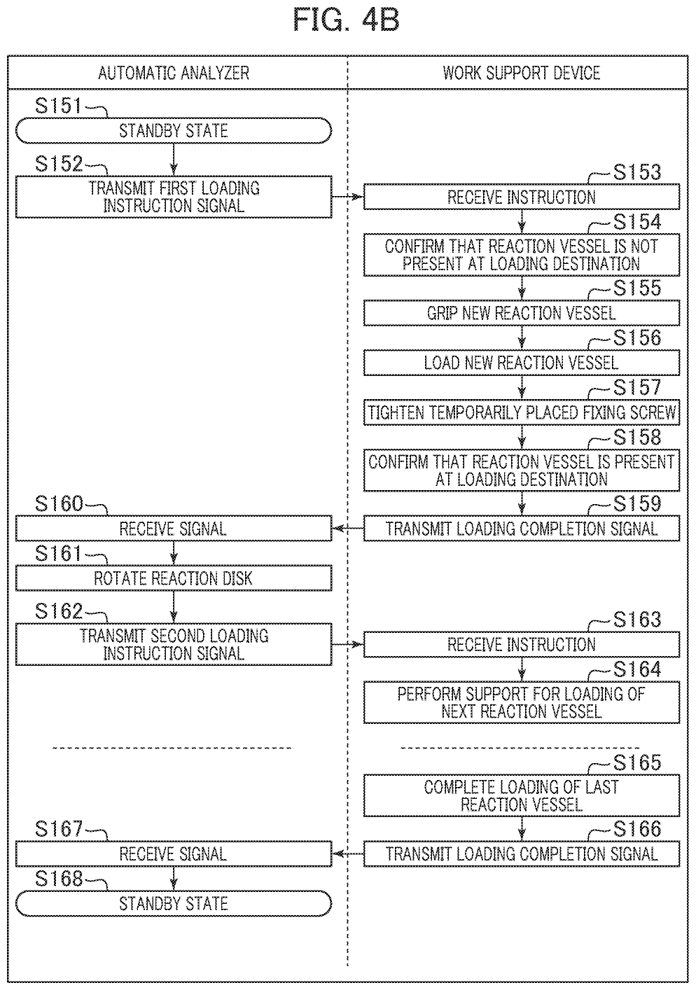

Example 1 is an example in which target storage members are a plurality of reaction vessels 201 on the circumference of the reaction disk 207. FIG. 4A is a flowchart illustrating operations of the automatic analyzer and the work support device 6 until all reaction vessels 201 to be discarded after being used are unloaded. FIG. 4B is a flowchart of operations of the automatic analyzer and the work support device 6 until all new reaction vessels 201 for replacement are loaded. When a plurality of reaction vessels 201 are arranged in a diameter direction of the reaction disk 207, a set of the plurality of reaction vessels 201 arranged in the diameter direction is a minimum unit to be loaded and/or unloaded.

In the present Example, while the automatic analyzer rotates the reaction disk 207, the work support device 6 sequentially unloads the plurality of reaction vessels 201 on the circumference of the reaction disk 207. After the unloading of all the reaction vessels is completed, while the automatic analyzer rotates the reaction disk 207 similarly, the work support device 6 sequentially loads new reaction vessels 201. A program for maintenance is installed in the automatic analyzer and the work support device 6 in advance, and the controllers of the devices are controlled based on the program.

As illustrated in FIG. 4A, first, the work time calculator 73 of the automatic analyzer calculates a replacement work day in advance based on information of a time for previous replacement of reaction vessels 201. When it is the replacement work day, the display unit 303 of the automatic analyzer issues an alarm (step S101). A method of issuing the alarm is not limited to displaying on the display unit 303 and may be another method of outputting audio or the like. Next, the work time calculator 73 calculates a time to terminate requested measurement or the like as a timing at which the measurement operation is not interrupted as much as possible (step S102). After that, when the requested measurement is terminated (step S103), the controller 71 of the automatic analyzer transmits a first unloading instruction signal to the work support device 6 via the communication unit 74 (step S104).

When the communication unit 610 of the work support device 6 receives the first unloading instruction signal from the automatic analyzer (step S105), the controller 602 of the work support device 6 controls the traveling unit 604 to cause the traveling unit 604 to travel and start to move toward a loading/unloading support position near the front of the reaction disk 207 of the automatic analyzer (step S106). In this case, the controller 602 of the work support device 6 analyzes an image captured by the camera 603 and calculates positions (distances and directions) of the reaction disk 207, the reaction vessel 201, the fixing screws 211, and the like to identify a location suitable for the unloading support work as the loading/unloading support position. When the movement to the loading/unloading support position is completed, the communication unit 610 of the work support device 6 transmits a movement completion signal to the automatic analyzer (step S107).

In addition, after extending the arm 211 toward a fixing screw 211, the controller 602 of the work support device 6 opens the hand 606 to cause the hand 606 to grip the fixing screw 211, rotates the hand 606 in a state in which the hand opening/closing detector 607 detects the gripping of the fixing screw 211, and removes the fixing screw 211 (step S109). Subsequently, after the controller 602 uses the hand opening/closing detector 607 to confirm the gripping of the fixing screw 211 and lifts up the arm 605, the controller 602 further moves the arm 605 to place the removed fixing screw 211 at a predetermined temporary placement location (step S110). The temporary placement location is confirmed using the camera 603 or the like. In addition, the temporary placement location may be the storage member holder 612 of the work support device 6.

Next, the controller 602 cancels the gripping by the hand 606 and uses the hand opening/closing detector 607 to confirm that the hand 606 is closed. After that, the controller 602 lifts up the arm 605 and moves the arm 605 toward the reaction vessel 201 targeted for unloading support. In addition, the controller 602 opens the hand 606 to cause the hand 606 to grip a gripping portion of the reaction vessel 201 (step S111), and lifts up the arm 605 in a state in which the hand opening/closing detector 607 detects the gripping of the reaction vessel 201. After that, the controller 602 controls the arm 605 to move the reaction vessel 201 to a predetermined discarding location such as the consumable storage unit 211 and opens the hand 606 to discard the reaction vessel 201 (step S112). Subsequently, after the controller 602 closes the hand 606 and uses the hand opening/closing detector 607 to confirm a closed state of the hand 606, the communication unit 610 transmits an unloading completion signal to the automatic analyzer (step S113). The discarding location is confirmed using the camera 603 or the like and may be the storage member holder 612.

When the communication unit 74 of the automatic analyzer receives the unloading completion signal (step S114), the controller 71 of the automatic analyzer rotates the reaction disk 207 by only one reaction vessel 201 as a preparation operation for unloading of the next reaction vessel 201 (step S115). When a position detector disposed on the reaction disk 207 detects that the reaction disk 207 rotated to a predetermined position, the communication unit 74 transmits a second unloading instruction signal to the work support device 6 (step S116).

When the communication unit 610 of the work support device 6 receives the second unloading instruction signal (step S117), the controller 602 of the work support device 6 supports unloading of the second reaction vessel 201 in the same manner as for the first reaction vessel 201 (step S118). After that, the same operation is repeated. In this case, the number of reaction vessels 201 on the reaction disk 207 is registered in advance in a storage unit (not illustrated) of the work support device 6. The controller 602 references the registered number to identify the number of times that the unloading support needs to be performed. Then, when the unloading of the last reaction vessel 201 on the reaction disk 207 is completed (step S119), the controller 602 uses the camera 603 or the like to confirm that a reaction vessel 201 is not present on the reaction disk 207. After that, the communication unit 610 transmits an unloading completion signal to the automatic analyzer (step S120).

When the communication unit 74 of the automatic analyzer receives the unloading completion signal (step S121), the automatic analyzer goes into the standby state (step S122). By temporarily going into the standby state before the next loading work, operator work such as cleaning a reaction tank can be performed at this timing.

Next, work of loading a new reaction vessel 201 is described with reference to FIG. 4B. First, the controller 71 of the automatic analyzer transmits a first loading instruction signal to the work support device 6 via the communication unit 74 (step S152).

When the communication unit 610 of the work support device 6 receives the first loading instruction signal from the automatic analyzer (step S153), the controller 602 of the work support device 6 uses the camera 603 or the like to confirm that a reaction vessel 201 is not present on the reaction disk 207 that is a loading destination (step S154). After that, the controller 602 moves the arm 605 toward the new reaction vessel 201 prepared at a predetermined preparation location in advance and targeted for loading support, and opens the hand 606 to cause the hand 606 to grip a gripping portion of the reaction vessel 201 (step S155). When the preparation location where the new reaction vessel 201 is prepared is far from the loading/unloading support position, the work support device 6 travels by the traveling unit 604 as necessary. In addition, the preparation location may be the storage member holder 612 of the work support device 6.

Subsequently, the controller 602 lifts up the arm 605 to move the reaction vessel 201 to the loading destination on the reaction disk 207 in a state in which the hand opening/closing detector 607 detects the gripping of the reaction vessel 201, and opens the hand 606 to load the reaction vessel 201 (step S156). In addition, after the controller 602 closes the hand 606 and uses the hand opening/closing detector 607 to confirm the closed state of the hand 606, the controller 602 lifts up the arm 605 to move the arm 605 to the temporary placement location where the fixing screw 211 is placed at the time of the unloading support. After that, the controller 602 opens the hand 606 to cause the hand 606 to grip the fixing screw 211, and lifts up the arm 605 in a state in which the hand opening/closing detector 607 detects the gripping by the hand 606. The controller 602 uses the camera 603 or the like to confirm the loading destination of the reaction vessel 201 and a fixed position of the fixing screw 211. After that, the controller 602 uses the arm 605 to insert the fixing screw 211 in a fixed position on the reaction disk 207, and rotates the hand 606 to tighten the fixing screw 211 (step S157). Next, the controller 602 cancels the gripping by the hand 606, uses the hand opening/closing detector 607 to confirm that the fixing screw 211 is not gripped. After that, the controller 602 lifts up the arm 605 and confirms that the reaction vessel 201 is present at the loading destination (step S158). After that, the communication unit 610 transmits a loading completion signal regarding the first reaction vessel 201 to the automatic analyzer (step S159).

When the communication unit 74 of the automatic analyzer receives the loading completion signal (step S160), the controller 71 of the automatic analyzer rotates the reaction disk 207 by one reaction vessel 201 as a preparation operation for loading of the next reaction vessel 201 (step S161). When the position detector disposed on the reaction disk 207 detects that the reaction disk 207 rotated to a predetermined position, the communication unit 74 transmits a second loading instruction signal to the work support device 6 (step S162).

When the communication unit 610 of the work support device 6 receives the second loading instruction signal (step S163), the controller 602 of the work support device 6 supports loading of the second reaction vessel 201 in the same manner as for the first reaction vessel 201 (step S164). After that, the same operation is repeated. Then, when the loading of the last reaction vessel 201 on the reaction disk 207 is completed (step S165), the communication unit 610 transmits a loading completion signal to the automatic analyzer (step S166).

When the communication unit 74 of the automatic analyzer receives the loading completion signal (step S167), the automatic analyzer goes into the standby state (step S168).

As described above, according the present Example, the automatic analyzer and the work support device 6 coordinate with each other so as to be able to automatically perform work of replacing a reaction vessel 201 and reduce manual work by the operator. Particularly, a reaction vessel 201 present on the back side (rear side) of the reaction disk 207 may be far from the operator and it may be difficult to replace the reaction vessel 201 present on the back side (backward side) of the reaction disk 207. However, in the present Example, the automatic analyzer rotates the reaction disk 207 and thus the work support device 6 can support loading and/or unloading of a reaction vessel at the same position on the front side (forward side) of the reaction disk 207. Therefore, the work support device 6 may not need to travel by the traveling unit 604 and to further extend the arm 605 and thus it is possible to reduce a time period required for replacement of a reaction vessel 201. In addition, in the present Example, a new reaction vessel 201 is not loaded immediately after a single reaction vessel 201 is unloaded, and new reaction vessels 201 are collectively loaded after all reaction vessels 201 are unloaded. Therefore, loading and/or unloading work is more efficient as a whole.

### Example 2

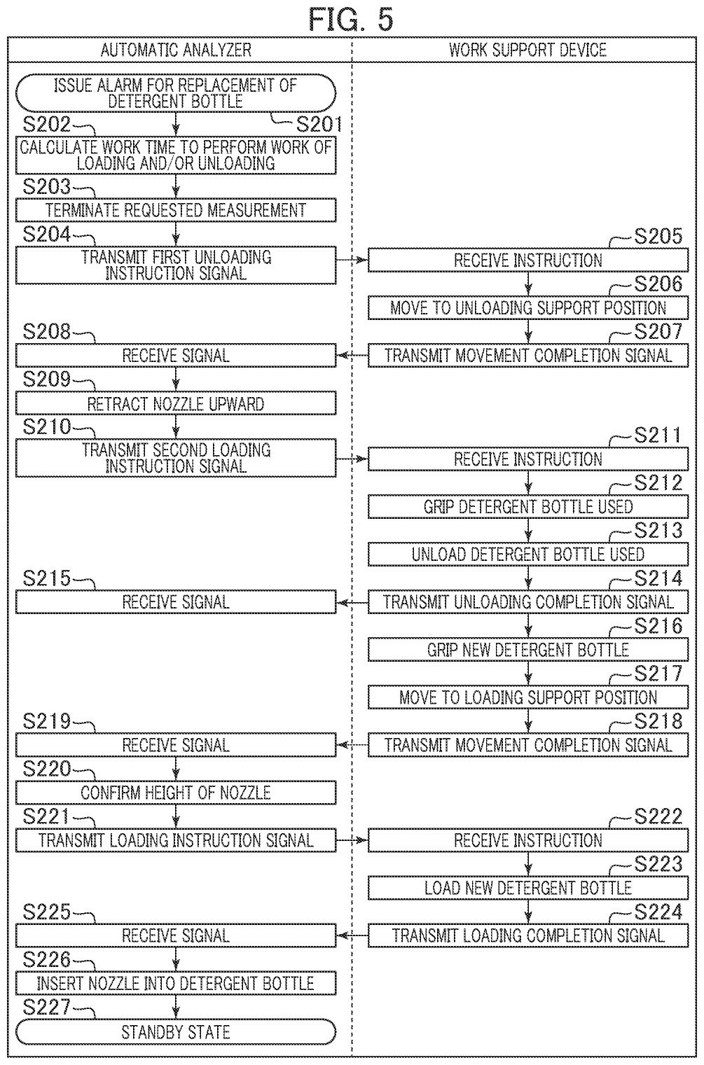

Example 2 is an example in which a target storage member is a detergent bottle 113. FIG. 5 is a flowchart illustrating operations of the automatic analyzer and the work support device 6 according to the present Example.

As illustrated in FIG. 5, first, when the weight sensor 117 or the like detects that a remaining amount in the detergent bottle 113 is smaller than a defined value set in advance, the automatic analyzer issues an alarm for replacement of the detergent bottle 113 (step S201). Next, the work time calculator 73 of the automatic analyzer calculates a work time to perform work of replacing the detergent bottle 113 based on the above-described remaining amount and information of requested measurement (step S202). After that, when it is the time to perform the replacement work at a time when the requested measurement is terminated, the controller 71 of the automatic analyzer shifts to the work of replacing the detergent bottle 113 (step S203) and transmits a first loading instruction signal to the work support device 6 via the communication unit 74 (step S204).

When the communication unit 610 of the work support device 6 receives the first loading instruction signal from the automatic analyzer (step S205), the controller 602 of the work support device 6 controls the traveling unit 604 to causes the traveling unit 604 to travel and start to move toward a loading/unloading support position near the front of the detergent bottle 113 of the automatic analyzer (step S206). When the movement to the loading/unloading support position is completed, the communication unit 610 transmits a movement completion signal to the automatic analyzer (step S207).

When the communication unit 74 of the automatic analyzer receives the movement completion signal from the work support device 6 (step S208), the controller 71 of the automatic analyzer controls the drive mechanism to retract the nozzle 115 upward as a preparation operation for unloading (step S209). After that, the controller 71 uses the nozzle detector 116 to confirm the height of the nozzle 115 and the communication unit 74 transmits a second unloading instruction signal to the work support device 6 (step S210).

When the communication unit 610 of the work support device 6 receives the second unloading instruction signal from the automatic analyzer (step S211), the controller 602 of the work support device 6 uses the camera 603 to confirm the position of the detergent bottle 113. After that, the controller 602 extends the arm 605 toward the detergent bottle 113, opens the hand 606 to cause the hand 606 to grip a gripping portion of the detergent bottle (step S212). Subsequently, the controller 602 moves the arm 605 toward the front side in a state in which the hand opening/closing detector 607 detects the gripping of the detergent bottle 113, and removes the detergent bottle 113. In addition, the controller 602 controls the traveling unit 604 and the arm 605 to unload the detergent bottle 113 to a predetermined discarding location (step S213) and opens the hand 606 to discard the detergent bottle 113. After that, after the controller 602 closes the hand 606 and uses the hand opening/closing detector 607 to confirm the closed state of the hand 606, the communication unit 610 transmits an unloading completion signal to the automatic analyzer (step S214).

In addition, after traveling by the traveling unit 604 as necessary, the controller 602 moves the arm toward a new detergent bottle 113 prepared at a predetermined preparation location and targeted for loading support and opens the hand 606 to cause the hand 606 to grip the gripping portion of the detergent bottle 113 (step S216). After that, the controller 602 controls the traveling unit 604 to causes the traveling unit 604 to start to move toward the loading/unloading support position (step S217). When the movement to the loading/unloading support position is completed, the communication unit 610 transmits a movement completion signal to the automatic analyzer (step S218).

When the communication unit 74 of the automatic analyzer receives the movement completion signal from the work support device 6 (step S219), the controller 71 of the automatic analyzer uses the nozzle detector 116 to confirm that the distal end of the nozzle 115 is located higher than the upper end of the detergent bottle 113 (step S220). After that, the communication unit 74 transmits a loading instruction signal to the work support device 6 (step S221).

When the communication unit 610 of the work support device 6 receives the loading instruction signal from the automatic analyzer (step S222), the controller 602 of the work support device 6 uses the camera 603 to confirm the position of a loading destination of the detergent bottle 113. The controller 602 controls the arm 605 to move the arm 605 toward the loading destination in a state in which the hand opening/closing detector 607 detects the gripping of the detergent bottle 113. In addition, the controller 602 opens the hand 606 to load the detergent bottle 113 (step S223). Next, the controller 602 uses the hand opening/closing detector 607 to confirm that the detergent bottle 113 is not gripped. The controller 602 uses the camera 603 and the weight sensor 117 to confirm that the detergent bottle 113 is present at the loading destination. After that, the communication unit 610 transmits a loading completion signal to the automatic analyzer (step S224).

When the communication unit 74 of the automatic analyzer 74 receives the loading completion signal (step S225), the controller 71 of the automatic analyzer lowers the nozzle 115 to insert the nozzle 115 into the detergent bottle 113 (step S226). After the controller 71 uses the nozzle detector 116 to confirm that the distal end of the nozzle 115 is located at a height position where the distal end is immersed in the liquid surface of a detergent, the automatic analyzer goes into the standby state (step S227).

As described above, in the present Example, after retracting the nozzle 115 upward as a preparation operation for work of replacing the detergent bottle 113, the automatic analyzer outputs an instruction signal for work support to the work support device. As a result, it is possible to automatically perform work of replacing the detergent bottle 113 that is a consumable without interference with the nozzle 115 and it is possible to reduce manual work by the operator. In the present Example, the discarding location where a detergent bottle 113 used is discarded and a preparation location where a new detergent bottle 113 is prepared can be the storage member holder 612 of the work support device 6 and it is possible to save a time period required to move the traveling unit 604 and the arm 605.

In addition, the work support device 6 according to the present Example can use the reader 609 to read information of the type, manufacturing date, expiration date, and the like of a detergent in a new detergent bottle 113 from a barcode or the like attached to the surface of the new detergent bottle 113. Therefore, according to the present Example, the work support device 6 can select a detergent bottle 113 with the most recent expiration date from among a plurality of detergent bottles 113 present at the preparation location and perform support for loading.

### Example 3

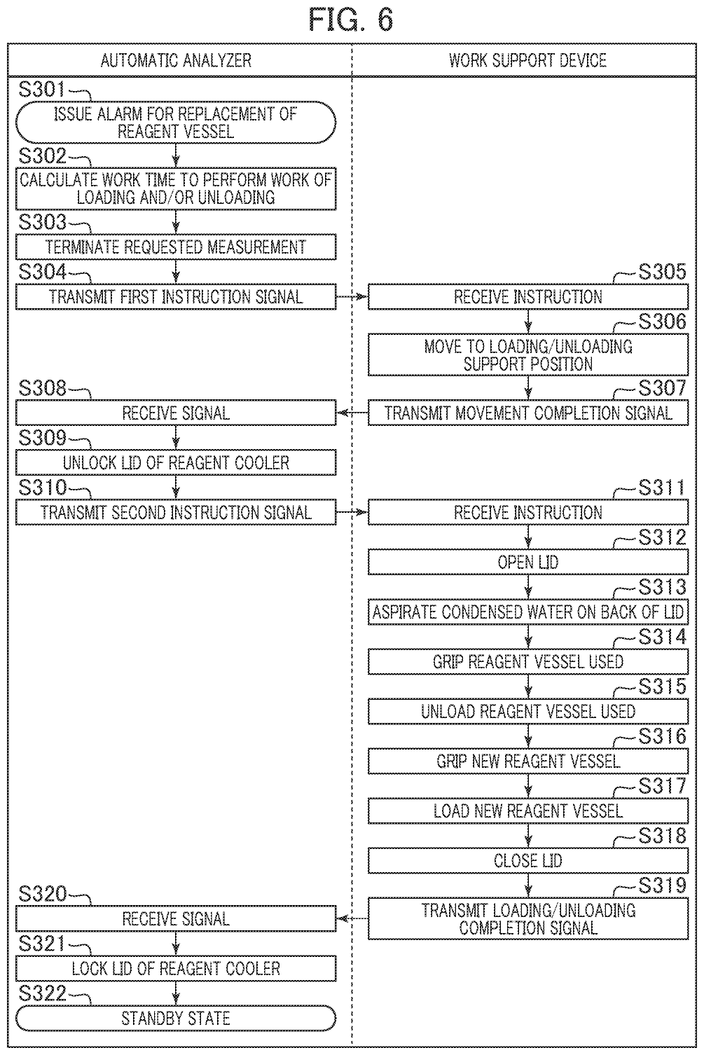

Example 3 is an example in which a target storage member is a reagent vessel 203. FIG. 6 is a flowchart illustrating operations of the automatic analyzer and the work support device 6 in the present Example.

As illustrated in FIG. 6, first, when a remaining amount in the reagent vessel 203 is smaller than a defined value set in advance, the automatic analyzer issues an alarm for replacement of the reagent vessel 203 (step S301). Next, the work time calculator 73 of the automatic analyzer calculates a work time to perform work of replacing the reagent vessel 203 based on the above-described remaining amount and information of requested measurement (step S302). After that, when it is the time to perform the replacement work at a time when the requested measurement is terminated, the controller 71 of the automatic analyzer shifts to the work of replacing the reagent vessel 203 (step S303) and transmits a first instruction signal to the work support device 6 via the communication unit 74 (step S304).

When the communication unit 610 of the work support device 6 receives the first instruction signal from the automatic analyzer (step S305), the controller 602 of the work support device 6 controls the traveling unit 604 to cause the traveling unit 604 to travel and start to move toward a loading/unloading support position near the front of the reagent cooler 204 of the automatic analyzer (step S306). When the movement to the loading/unloading support position is completed, the communication unit 610 transmits a movement completion signal to the automatic analyzer (step S307).

When the communication unit 74 of the automatic analyzer receives the movement completion signal from the work support device 6 (step S308), the controller 71 of the automatic analyzer controls the drive mechanism to unlock the lid 212 of the reagent cooler 204 as a preparation operation for unloading (step S309). After that, the controller 71 uses the nozzle detector 116 to confirm the height of the nozzle 115. Then, the communication unit 74 transmits a second instruction signal to the work support device 6 (step S310).

When the communication unit 610 of the work support device 6 receives the second instruction signal from the automatic analyzer (step S311), the controller 602 of the work support device 6 uses the camera 603 to confirm the position of the lid 212 of the reagent cooler 204. After that, the controller 602 controls the arm 605 and the hand 606 to cause the arm 605 and the hand 606 to grip and lift up a gripping portion of the lid 212 and move the lid 212 to a location separate from the reagent cooler 204 (step S312).

Subsequently, the controller 602 controls the aspiration unit 611 to aspirate condensed water adhering to the back surface of the lid 212 (step S313). Next, the controller 602 uses the camera 603 to confirm the position of the reagent vessel 203 present on the reagent disk and targeted for unloading support. After that, the controller 602 controls the arm 605 and the hand 606 to cause the hand 606 to grip the gripping portion of the reagent vessel 203 (step S314). In addition, the controller 602 causes the traveling unit 604 to move to a predetermined discarding position and causes the arm 605 and the hand 606 to discard the reagent vessel 203 used (step S315).

After that, the controller 602 causes the traveling unit 604 to travel and causes the hand 606 to grip a gripping portion of a new reagent vessel 203 prepared at a predetermined preparation location and targeted for loading support as necessary (step S316). In addition, the controller 602 controls the traveling unit 604 to cause the traveling unit 604 to move to the loading/unloading support position and controls the arm 605 and the handle 606 to load the new reagent vessel 203 onto the reagent disk (step S317). Subsequently, the controller 602 causes the arm 605 and the hand 606 to attach the lid 212 to the upper opening portion of the reagent cooler 204 (step S318). Then, the communication unit 610 transmits an loading/unloading completion signal to the automatic analyzer (step S319). When a plurality of reagent vessels 203 to be replaced are present, the lid 212 is attached and a loading/unloading completion signal is transmitted by the same operation after completion of replacement of all the reagent vessels 203.

When the communication unit 74 of the automatic analyzer receives the loading/unloading completion signal from the work support device 6 (step S320), the controller 71 of the automatic analyzer locks the lid 212 of the reagent cooler 204 (step S321) and the automatic analyzer goes into the standby state (step S322).

As described above, in the present Example, the automatic analyzer unlocks the lid 212 of the reagent cooler 204 as a preparation operation for work of replacing a reagent vessel 203 and then outputs an instruction for work support to the work support device. As a result, it is possible to automatically perform work of replacing the reagent vessel 203 that is a consumable and to reduce manual work by the operator.

In addition, in a case where the work support device 6 supports loading and/or unloading, the automatic analyzer can efficiently perform work of loading and/or unloading when the reagent disk is rotated such that a reagent vessel 203 to be replaced is located on the front side (forward side) of the reagent cooler 204. In addition, the automatic analyzer may include a mechanism that can unlock the lid 212 and open and close the lid 212.

Even in the present Example, a location where a reagent vessel 203 used is discarded and a location where a new reagent vessel 203 is prepared may be the storage member holder 612 of the work support device 6, and the hand opening/closing detector 607 may confirm whether a reagent vessel 203 and the lid 212 are gripped. In addition, instead of aspirating condensed water on the back surface of the lid 212 of the reagent cooler 204, the lid 212 may be continuously kept horizontal while being confirmed with the camera 603 to prevent condensed water from gathering and falling.

Each of Examples are described above in detail to clearly explain the present invention and are not necessarily limited to the examples including all the configurations described. In addition, a configuration of a certain Example can be added to a configuration of another Example. Furthermore, regarding a part of the configurations of Examples, it is possible to add, remove, and replace another configuration. For example, in Examples 1 to 3 described above, the examples of the work of replacing a reagent vessel, a detergent bottle, and a reagent vessel as storage members are described, but work regarding loading and collecting a specimen vessel as a storage member may be performed.

### LIST OF REFERENCE SIGNS

1: Automatic analyzer, 103: Reagent vessel, 104: Reagent cooler, 105: Specimen dispensing mechanism, 106: Reagent dispensing mechanism, 107: Reaction acceleration unit, 108: Measurement unit, 110: Specimen aspiration device, 111: Consumable storage unit, 112: Consumable transport unit, 113: Detergent bottle, 114: Flow path, 115: Nozzle, 116: Nozzle detector, 117: Weight sensor, 118: Liquid surface detector, 2: Automatic analyzer, 203: Reagent vessel, 204: Reagent cooler, 205: Specimen dispensing mechanism, 206: Reagent dispensing mechanism, 207: Reaction disk, 208: Measurement unit, 210: Specimen aspiration device, 211: Fixing screw, 212: Lid, 3: Control device, 301: Controller, 302: Communication unit, 303: Display unit, 4: Specimen transport device, 5: Specimen vessel, 6: Work support device, 601: Body, 602: Controller, 603: Camera, 604: Traveling unit, 605: Arm, 606: Hand, 607: Hand opening/closing detector, 608: Obstacle sensor, 609: Reader, 610: Communication unit, 611: Aspiration unit, 612: Storage member holder, 71: Controller, 72: Drive mechanism, 73: Work time calculator, 74: Communication unit

1-12. (canceled)

13. An automatic analyzer comprising:
a drive mechanism that is driven to use a specimen or reagent stored in a storage member;
a controller that controls the drive mechanism; and
a communication unit that communicates with a work support device that performs work support to support work of loading and/or unloading the storage member, wherein
when the communication unit receives a completion signal for first work support from the work support device, the controller automatically controls the drive mechanism based on the signal from the work support device to perform a preparation operation for the loading and/or unloading and controls the communication unit to automatically transmit an instruction signal for second work support to the work support device.

14. The automatic analyzer according to claim 13, wherein
the work support device is a self-propelled robot that is autonomously driven to perform the work support,
the first work support is to cause the work support device to travel and move to a predetermined location after the communication unit transmits a first instruction signal to the work support device,
the preparation operation is to control the drive mechanism by the controller to make the storage member replaceable, and
the second work support is to replace the storage member by the work support device in accordance with a second instruction signal transmitted by the communication unit after the preparation operation is completed.

15. The automatic analyzer according to claim 13, wherein
the storage member is a plurality of reaction vessels that store a reaction solution in which the specimen and the reagent are mixed, and are arranged on a circumference of a reaction disk,
the drive mechanism rotates the reaction disk,
the first work support is support for replacement of a first reaction vessel by the work support device when the first reaction vessel to be replaced is present at a predetermined position,
the preparation operation is an operation to be performed by the controller to control the drive mechanism to rotate the reaction disk such that a second reaction vessel to be replaced next is present at the predetermined position, and
the second work support is support for replacement of the second reaction vessel by the work support device when the second reaction vessel is present at the predetermined position.

16. The automatic analyzer according to claim 14, wherein
the storage member is a detergent bottle storing a detergent that is a system reagent,
the drive mechanism moves a nozzle in a vertical direction, the nozzle being configured to aspirate the detergent from the detergent bottle,
the preparation operation is to retract the nozzle upward by the drive mechanism, and
the second work support is to replace the detergent bottle by the work support device.

17. The automatic analyzer according to claim 14, wherein
the storage member is a plurality of reagent vessels that store a reagent and are arranged on a circumference of a reagent disk in a reagent cooler,
the drive mechanism is configured to unlock a lid of the reagent cooler,
the preparation operation is to unlock the lid by the drive mechanism, and
the second work support is to replace the reagent vessels by the work support device.

18. The automatic analyzer according to claim 13, further comprising a work time calculator that calculates a work time to load and/or unload the storage member, wherein
the communication unit transmits an instruction signal for the first work support to the work support device based on the work time calculated by the work time calculator.

19. A work support device that performs work support to support work of loading and/or unloading a storage member that is used in an automatic analyzer, the work support device comprising:
a communication unit that communicates with the automatic analyzer;
a traveling unit that travels to a location different from the automatic analyzer according to a type of the storage member;
a hand that grips and releases the storage member;
an arm that moves the hand to a predetermined position; and
a controller that controls the communication unit, the traveling unit, the hand, and the arm, wherein
when the communication unit receives a first instruction signal from the automatic analyzer, the controller completes the movement to the predetermined position by the traveling unit and transmits a movement completion signal to the automatic analyzer after the completion of the movement, and
when the communication unit receives a second instruction signal from the automatic analyzer that automatically performed a preparation operation based on the movement completion signal, the controller supports loading or unloading of the storage member by the arm and the hand.

20. The work support device according to claim 19, further comprising a reader that reads identification information given to the storage member, wherein
the controller supports loading of the predetermined storage member among a plurality of the storage members based on the identification information.

21. The work support device according to claim 19, wherein
the work support device includes a storage member holder that holds the storage member to be newly loaded to the automatic analyzer or the storage member to be unloaded for discarding.

22. The work support device according to claim 19, further comprising a reader that identification information given to the storage member, wherein
the controller supports, based on the identification information, loading of the storage member with the most recent expiration date among a plurality of the storage members in the storage member holder.

23. The work support device according to claim 19, further comprising an aspiration unit that aspirates condensed water on a back surface of a lid of a reagent cooler of the automatic analyzer.

24. An automatic analysis system comprising:
an automatic analyzer; and
a work support device that communicates with the automatic analyzer to perform work support to support work of loading and/or unloading of a storage member that is used in the automatic analyzer, wherein
the automatic analyzer includes a drive mechanism that is driven to use a specimen or reagent stored in the storage member,
the work support device includes a traveling unit, a hand that grips and releases the storage member, and an arm that moves the hand to a predetermined position,
when the automatic analyzer transmits a first instruction signal to the work support device, the work support device moves to a predetermined location by the traveling unit,
the automatic analyzer automatically controls the drive mechanism based on a movement completion signal from the work support device to perform a preparation operation for the loading and/or unloading, and automatically transmits a second instruction signal to the work support device, and
the work support device controls the arm and the hand to replace the storage member.
